(19) United States
(12) Patent Application Publication
(10) Pub. No.: US 2007/0295279 A1
(43) Pub. Date: Dec. 27, 2007

(54) Universal pet door cover

(76) Inventors: Alix Vis, New Milford, PA (US); June Arneil, Uniondale, PA (US)

Correspondence Address: L. ZALE PATENT LAW OFFICE, 334 SOUTH FRANKLIN ST., WILKES-BARRE, PA, 18702, US

(21) Appl. No.: 11/820,974

(22) Filed: Jun. 21, 2007

Related U.S. Application Data
(60) Provisional application No. 60/815,711, filed on Jun. 22, 2006.

(51) Int. Cl. A01K 1/03; A01K 1/035

(52) U.S. Cl. 119/484

(57) ABSTRACT

A pet door cover assembly is described which completely encloses a pet door to seal off drafts and leakage. It employs a cover large enough to cover the entire pet door and frame. It is preferably made of three layers, being a water resistant outer layer, a thermal insulation layer and an aesthetic layer having a pleasing surface or design. The cover is attached to the door or wall using an attachment means. The attachment means may be a hook and loop attachment, magnets and metal plates, elastic material or mechanical screws and hooks. The cover preferably employs a bendable wire, or other deformable means to be able to retain a shape. This is extremely useful in making a seal on non-flat surfaces. The bendable or deformable nature allows the cover to match the contour of the wall or door to create a tight seal.

### CROSS REFERENCES TO RELATED INVENTIONS

This application claims priority from U.S. Provisional Patent Application “Universal Pet Door Cover” by Alix Vis and June Arneil, Ser. No. 60/815,711 filed Jun. 22, 2006, hereby incorporated by reference as if set forth in its entirely herein.

### BACKGROUND OF THE INVENTION

1. Field of the Invention

The present invention relates to an improved cover for a pet door, and more specifically to an improved cover for a pet door which seals out weather.

2. Discussion of Related Art

Pet doors are used to allow pets such as dogs, cats or other animals, to enter and leave a building. These pet doors must be easy to open and close allowing the pet to pass through these doors without assistance. Since these doors require very little force to open, they typically do not seal very well.

These doors are made by cutting an opening in the door or wall, inserting a frame then attaching a hinged flap or door to the frame.

It is common for the pets to freely use the pet door during the spring, summer or fall months. It may not be as common to use the door during the winter months. Typically, these pet doors are sealed during these winter months to stop drafts and water leakage.

Several prior designs exist to seal the pet doors.

U.S. Pat. No. 5,406,748 Davlantes discloses a tapered door. It has the ability to be locked but does not discuss coverings or how to stop leakage of air where the door frame attaches to a door or wall.

Marsh U.S. Pat. No. 6,385,909 B1 discloses a cammed door which aids in keeping itself closed. It does not disclose coverings when not in use, or methods of sealing leaks.

Evans U.S. Pat. No. 4,840,217 discloses a succession of weather resistant doors. These do not have a particularly desirable appearance, and do not address air leaks where the assembly connects to the door.

Davlantes U.S. Pat. No. 5,735,079 discloses a sliding flat plate which is used as a cover when not in use. It appears to be weather resistant but again, does not disclose how to stop air leaks where the assembly meets the door.

Only Gribble U.S. Pat. No. 6,725,806 B1 discloses the use of insulation materials. However, Gribble does not cover the portion where the frame attaches to the door.

None of the patents found in the search address the drafts, air and water leakage where the frame is attached to a door or wall or the aesthetics of the pet door.

Currently, there is a need for a pet door which stops drafts, is water resistant and is aesthetically pleasing.

### SUMMARY OF THE INVENTION

One embodiment of the present invention is a cover assembly for providing a tight seal over a pet door assembly having a pet door frame attached to a wall or door, surrounding a hole through the wall or door, and a movable pet door attached to the frame, the cover assembly comprising:
a) a cover having a plurality of layers, with at least one layer being a thermal insulator, and the cover being deformable so as to contour to the door or wall;
b) an attachment means for attaching the cover assembly to the wall or door to which said pet frame connects.

In additional embodiments, the attachment means is a hook and loop attachment means similar to Velcro®, magnets and metal plates, screws and hooks, or other conventional attachment means.

### OBJECTS OF THE INVENTION

It is an object of the present invention to provide a novel pet door cover used to cover a pet door that is not in operation, which stops drafts.

It is another object of the present invention to provide a novel pet door cover used to cover a pet door that is not in operation, which stops leakage of water and moisture.

It is another object of the present invention to provide a novel pet door cover used to cover a pet door that is not in operation which is aesthetically pleasing.

It is another object of the present invention to provide a novel pet door cover that is universal having the ability to cover a variety of different pet doors.

### BRIEF DESCRIPTION OF THE DRAWINGS

The advantages of the instant disclosure will become more apparent when read with the specifications and the drawings, wherein:

FIG. 1 is an overall view of a system according to one embodiment of the present invention.

FIG. 2 is a side sectional view of the system of FIG. 1 as viewed from lines “II”-“II” showing the attachment means making a seal with an irregular surface.

FIG. 3 is a side sectional view of the system of FIG. 1 as viewed from lines “III”-“III” showing the cover attaching to the door and sealing off the pet door frame.

### DETAILED DESCRIPTION OF THE INVENTION

Pet doors, as described above, are known and have been used for quite some time. In many of these, the pet door does not seal against the door frame, and the door frame may work its way away from the wall or door onto which it is attached, creating leakage. Several prior art designs have recognized the air and water leakage past the hinged door. However, none of them address the second problem in which there is leakage between the frame of the pet door and a wall or door to which it is attached.

Not only is there air leakage and drafts which pass through the pet door assembly into and out of the building, but there's also a thermal leakage directly through the very thin prior art pet doors. Although several of the prior art methods seal the pet doors, only one mentions the use of insulation.

The present invention employs an improved cover having several layers of which, at least one is thermal insulation.

The prior art designs assume that the attachment surface is flat. In reality, there are many doors which have recesses and protrusions as decorative elements. For instance, a door may employ several raised boards which cross at the center of the door.

The prior art methods of sealing pet doors do not contemplate making a tight seal against the wall or door which is not flat.

The invention may best be understood in connection with a description of the attached drawings.

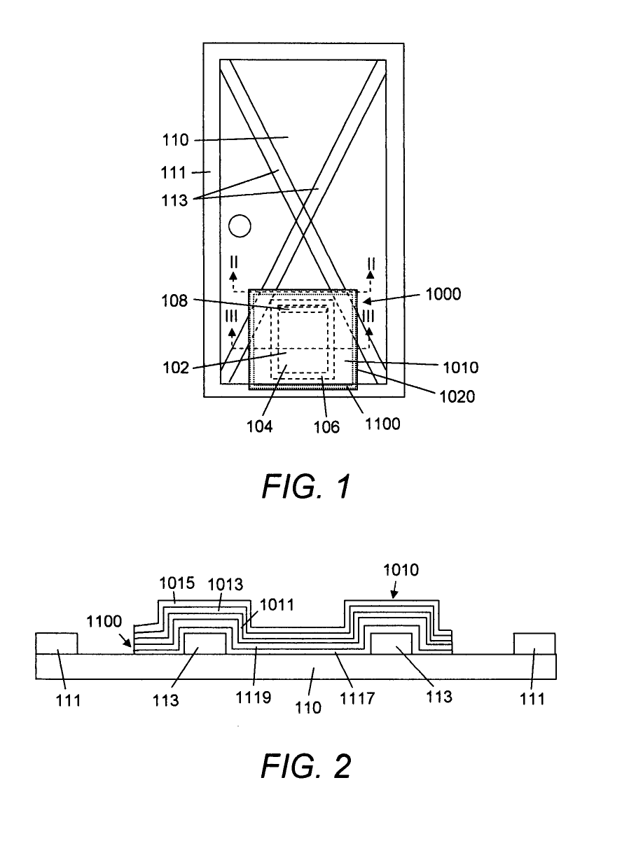

In FIG. 1, a door 110 is shown having an opening 102 cut through it near the bottom. A pet door frame 106 is attached to door 110 around the perimeter of opening 102.

Pet door frame 106 is fitted with a pet door 104 which is typically attached to frame 106 at the top by a hinge 108. This is designed to open with little force, thereby allowing a pet to push through the door in either direction. There is typically a loose fit to allow the low operation force, thereby allowing leakage of air, causing drafts, loss of heat and/or air conditioning.

As stated above, improper installation, warping or wear over time, cause leaks to form between pet frame 106 and door 110.

Even with the use of a plate which slides into the frame, as disclosed in the prior art device by Davlantes U.S. Pat. No. 5,735,079 described above, there is leakage where the pet door frame 106 meets the door 110.

The present invention 1000 is designed to be attached over the entire pet frame 106 to reduce leaks and drafts. Cover 1010 is shown here attached to door 110 having an irregular surface contour. Door 110 has a raised perimeter 111 and two crossing raised slats 113.

Cover 1010 is attached to door 110 with attachment devices 1100. These attachment devices are required to tightly hold cover 1010 against door 110, and form to the contours to cause a tight seal, stopping leakage of air and moisture. These attachment means may be the two parts of the hook and loop attachments such as those sold under the name “Velcro®”. Attachment may be by attaching metal plates (not shown) or strips to door 110 and attaching magnets (not shown) to cover 110.

Similarly, mechanical devices such as hooks or snaps can be screwed into door 110, with hook or snap receivers attached to the cover holding the cover 1010 and door 110 together. In the areas between attachment points, there may be the need for a semi-rigid deformable edge 1020 embedded in the perimeter of cover 1010. The deformable edge is attached to the door 110 at attachment points, and presses sections of the cover between the attachment points against the door 110, making a seal. The use of bendable wire, plastics, or elastic may be used.

In another embodiment, a deformable magnet is embedded in the entire edge of the cover 1010 which may be bent to the contour of door 110, and attach to a metal door 110, or to a continuous metal strip on door 110.

FIG. 2 is a side sectional view of the system of FIG. 1 as viewed from lines “II”-“II” showing the attachment means making a seal with an irregular surface.

Cover 1010 is shown attached to door 110 with attachment means 1100, here being a continuous attachment, such as two corresponding strips 1117, 1119 of hook and loop fabric (similar to Velcro@) which attach to each other. It may also be a long deformable magnet and a metallic strip. The deformable attachment device 1100 is formed by the user to fit the contour of door 110, creating a tight seal to the surface over slats 113.

Cover 1010 has several layers. The outer layer closest to the outside elements is preferably a waterproof layer 1011.

An insulation layer 1013 is required to reduce the transmitted cold, or heat and insulate the area inside of door 110.

Optionally, a decorative layer 1015 is employed. This may have graphics, patterns or other aesthetically pleasing artwork. The present invention covers the pet door when it is not in use and provides a more aesthetically pleasing appearance.

In an alternative embodiment, a deformable edge (1020 of FIG. 1) is embedded in cover 1010 which may be bent to a given shape and retain that shape.

Cover 1010 and attachment device 1100 follow the contour of the surface of door 110 and make a tight seal between cover 1010 and door 110. These bend over slats 113 and back to the surface of door 110.

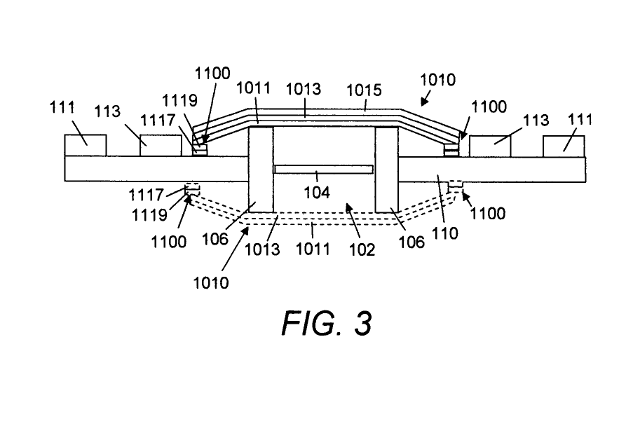

FIG. 3 is a side sectional view of the system of FIG. 1 as viewed from lines “III”-“III” showing a view across the center of the pet door 104. The cover 1010 is attached to door 110 with attachment device 1100 against pet door frame 106 sealing off the pet door frame 106.

Here the cover 1010 is pulled and held by attachment means 1117 and 1119.

The cover 1010 is held tightly against door 110 which pulls cover 1010 against frame 106 which is raised with respect to the door 110 surface. This causes opening 102 of frame 106 to be sealed at this point. If there is no leakage between frame 106 and door 110, this would suffice to reduce or eliminate air or moisture leakage.

The design then has the second seal at the deformable edge of cover 1010 to insure that there is no leakage between the frame 106 and door 110.

Again it can be seen that cover 1010 has several layers. The outer layer of cover 1010 closest to the outside elements is preferably a waterproof layer 1011.

Insulation layer 1013 reduces the transmitted cold or heat and insulates the area inside of door 110.

Decorative layer 1015 may be employed.

Also, when the pet door is in use and cover 1010 is not applied, first part 1117 of attachment device 1100 is attached to door 110. An optional frame, similar in shape to a picture frame, having similar dimensions to cover 1010, employs material similar to the second part 1119 of the attachment device 1100, causing it to attach to the existing part 1117 connected to door 110. Therefore, the frame is attached to door 110 over attachment 1117 to cover them.

In still another embodiment of the present invention, an additional cover 1010 is attached to the outside of the door 110, shown in phantom in FIG. 3. Again, an attachment device 1100 is used to attach cover 1010 to door 110. The attachment device shown is a first part and second part hook and loop type attachment device, 1117, 1119, respectively.

In this embodiment, a waterproof layer 1011 is the outermost layer.

Inside of layer 1011 is an insulating layer 1013. Other layers such as a decorative layer may also be employed.

Since other modifications and changes varied to fit particular operating requirements and environments will be apparent to those skilled in the art, the invention is not considered limited to the example chosen for the purposes of disclosure and covers all changes and modifications which do not constitute departures from the true spirit and scope of this invention.

What is claimed is:

1. A cover assembly for providing a tight seal over a pet door assembly having a pet door frame attached to a structure with an irregular surface, surrounding a hole through the structure and a movable pet door attached to the frame, the cover assembly comprising:
a) a cover having a plurality of layers, with at least one layer being a thermal insulator, and the cover being deformable so as to contour to the structure;
b) an attachment means for attaching the deformed cover assembly to the irregular structure to which said pet frame connects to create a draft-resistant seal.

2. The cover assembly of claim 1 wherein the attachment means comprises:
a) a deformable magnet connected to one of the cover or the structure, and;
b) at least one metal plate attached to the other of the cover or the structure.

3. The cover assembly of claim 1 wherein the attachment means comprises:
a) a deformable magnet attached to one of the cover or the structure, and;
b) a metal portion being part of the other of the cover or the structure.

4. The cover assembly of claim 1, wherein the attachment means comprises:
A hook material adapted to interact with a loop material to cause attachment, attached to one of the structure or the cover; and
A loop material adapted to interact with the hook material to cause attachment, attached to the other of the structure or cover.

5. The cover assembly of claim 1, wherein the attachment means comprises:
a) mechanical fasteners attached to one of the cover or structure, and
b) mechanical fastener receivers on the other of the cover or structure.

6. The cover assembly of claim 1, wherein the attachment means comprises an elastic material in the edge of the cover which fits securely around the pet door frame.

7. The cover assembly of claim 1, wherein the structure is a door.

8. The cover assembly of claim 1, wherein the structure is a wall.

9. The cover assembly of claim 1, wherein cover has an outer layer closest to the outside elements is a waterproof layer.

10. The cover assembly of claim 1, wherein cover has an inner layer which is most visible that is a decorative layer.

11. A cover assembly for providing a tight seal over a pet door assembly having a raised pet door frame attached to a structure with an irregular surface, surrounding a hole through the structure and a movable pet door attached to the frame, the cover assembly comprising:
a) a cover having a plurality of layers, with at least one layer being a thermal insulator, and the cover having at least one deformable edge so as to contour to the irregular structure;
b) an attachment means for attaching the deformed cover edge to the irregular structure to which said pet frame connects to create a draft-resistant seal, the cover also being sized and shaped so as to become taunt and press against the raised pet door frame creating a second seal.

12. The cover assembly of claim 11 wherein the attachment means comprises:
a) a deformable magnet connected to one of the cover or the structure, and;
b) at least one metal plate attached to the other of the cover or the structure.

13. The cover assembly of claim 11 wherein the attachment means comprises:
a) a deformable magnet attached to one of the cover or the structure, and;
b) a metal portion being part of the other of the cover or the structure.

14. The cover assembly of claim 11, wherein the attachment means comprises:
a) A hook material adapted to interact with a loop material to cause attachment, attached to one of the structure or the cover; and
b) A loop material adapted to interact with the hook material to cause attachment, attached to the other of the structure or cover.

15. The cover assembly of claim 11, wherein the attachment means comprises:
a) mechanical hooks attached to one of the cover or structure, and
b) mechanical loops on the other of the cover or structure.

16. The cover assembly of claim 11, wherein the attachment means comprises an elastic material in the edge of the cover which fits securely around the pet door frame.

17. The cover assembly of claim 11, wherein the structure is a door.

18. The cover assembly of claim 11, wherein the structure is a wall.

19. The cover assembly of claim 11, wherein cover has an outer layer closest to the outside elements is a waterproof layer.

20. The cover assembly of claim 11, wherein cover has an inner layer which is most visible that is a decorative layer.
